(19) United States
(12) Patent Application Publication
(10) Pub. No.: US 2015/0364787 A1
(43) Pub. Date: Dec. 17, 2015

(54) Composite Electrolytes for Low Temperature Sodium Batteries

(71) Applicants: Hui Zhang, Morgantown, WV (US); Xingbo Liu, Morgantown, WV (US)

(72) Inventors: Hui Zhang, Morgantown, WV (US); Xingbo Liu, Morgantown, WV (US)

(21) Appl. No.: 13/693,359

(22) Filed: Dec. 4, 2012

Related U.S. Application Data
(60) Provisional application No. 61/567,422, filed on Dec. 6, 2011.

(51) Int. Cl. H01M 10/0562; H01M 10/054

(52) U.S. Cl. CPC H01M 10/0562; H01M 10/054

(57) ABSTRACT

A solid electrolyte composite is provided comprising a NaSICON framework of the formula NaₓA_{y}B_{z}P_{3-z}O_{w} wherein A is one or more metal ions, B is one or more ions having a pentavalence, and x is a number ranging from 1 to 12, y is a number ranging from 1 to 2, z is a number ranging from 0 to 3, and w is a number ranging from 4 to 12, wherein B is present or absent, and a glass material. A battery is disclosed having at least one cathode and anode and the solid electrolyte glass phase composite described above disposed between at least one of the anode and cathode. A method for making the solid electrolyte composite is set forth.

### CROSS REFERENCE TO RELATED APPLICATION

This utility patent application claims the benefit of priority to co-pending U.S. Provisional Patent Application Ser. No. 61/567,422, filed Dec. 6, 2011. The entire contents of U.S. Provisional Patent Application Ser. No. 61/567,422 is incorporated by reference into this utility patent application as if fully rewritten herein.

### GOVERNMENT INTEREST

Not applicable.

### BACKGROUND OF THE INVENTION

1. Field of the Invention

This invention relates to a solid electrolyte composite having a sodium-super-ionic-conductor (NaSICON) framework of the formula NaₓA_{y}B_{z}P_{3-z}O_{w} wherein A is one or more metal ions, B is one or more ions with a pentavalence, for example but not limited to Si5+, V5+ and Nb5+, and x is a number ranging from 1 to 12, y is a number ranging from 1 to 2, z is a number ranging from 0 to 3, and w is a number ranging from 4 to 12, and a glass material. “B” in the formula NaₓA_{y}B_{z}P_{3-z}O_{w} may be present or absent. Specifically, this invention relates to a sodium-ion conducting solid electrolyte composite. The glass phase is preferably based on a Na₂O—B₂O₃. The solid electrolyte glass phase composite may be used, for example but not limited to, in sodium-ion batteries, thin film batteries, pH sensors, and separation devices. A battery having a sodium-super-ionic-conductor (NaSICON) framework of the formula NaₓA_{y}B_{z}P_{3-z}O_{w} glass composite electrolyte is also provided.

2. Description of the Background Art

Most currently available Na-batteries use tubular designs with β-Al₂O₃ as the solid electrolyte. These batteries consume considerable energy to maintain their operating temperature (typically 300-350° C.), are difficult to stop and start negating any ability to follow load, and suffer from materials corrosion related to their high operating temperature. All these factors contribute to high operating costs.

X. Lu, G. Xia, J. Lemmon, Z. Yang, Journal of Power Sources 195 (2009) 2431, pointed out that NaSICON materials are probably the best choice due to low thermal expansion behavior and high conductivity at relatively low temperatures. Further, EaglePicher (Joplin, Mo., US) and Pacific Northwest National Laboratory (PNNL) are developing a planar design with β-Al2O3 as the solid electrolyte that show several advantages thus far: a shorter diffusion path, reduced ohmic and power loss; increased active electrode area per volume power density leading to a quicker response; better modularity and suitability for mass production; easier heat management and improved component reliability; and, lower cost.

To further lower the operating temperature, we have developed a new class of electrolytes based on sodium-super-ionic-conductor, or NaSICON, materials which offer the promise of operating temperatures in the range of 120° C. to 250° C. NaSICON suffers from drawbacks though, including low grain boundary conductivity, high porosity, and long-term instability. While the advantages of glass materials including absence of grain boundary effects, ease of manufacture and forming, and the potential for a wide range of chemical stability to oxidizing and reducing conditions, can compensate for the difficulties of NaSICON. Our new composite electrolyte of NaSICON/glass takes advantage of the benefits of both NaSICON and glasses. A planar configuration of a Na battery with our NaSCION/glass composite electrolyte is also provided.

### SUMMARY OF THE INVENTION

The present invention has met the above-described needs. The present invention provides (i) a solid electrolyte composite comprising a sodium-super-ionic-conductor framework of the formula NaₓA_{y}B_{z}P_{3-z}O_{w} wherein A is one or more metal ions, B is one or more ions with a pentavalence, for example but not limited to Si5+, V5+ and Nb5+, and x is a number ranging from 1 to 12, y is a number ranging from 1 to 2, z is a number ranging from 0 to 3, and w is a number ranging from 4 to 12, wherein B is present or absent, and a glass material; (ii) a sodium-ion conducting solid electrolyte composite; (iii) a battery having an improved solid electrolyte glass containing composite; and (iv) a method of producing an improved solid electrolyte NaSICON/glass composite.

The present invention provides a solid electrolyte composite comprising a sodium-super-ionic-conductor framework of the formula NaₓA_{y}B_{z}P_{3-z}O_{w} wherein A is one or more metal ions, B is one or more ions having a pentavalence, and x is a number ranging from 1 to 12, y is a number ranging from 1 to 2, z is a number ranging from 0 to 3, and w is a number ranging from 4 to 12, and a glass material. “B” in the formula NaₓA_{y}B_{z}P_{3-z}O_{w} may be present or absent. As used herein, the term “ion” refers to an element of the periodic table that has either lost or gained one or more electrons. Preferably, “B” in the formula NaₓA_{y}B_{z}P_{3-z}O_{w} is one or more ions having a valence of 5+, such as for example, but not limited to Si5+, V5+ and Nb5+. The molar ratio of the NaₓA_{y}B_{z}P_{3-z}O_{w} to the glass material ranges from about 100:1 to about 1:4. Preferably, the solid electrolyte composite of the present invention, as described herein, includes a glass material that is one or more selected from the group consisting of Na₂O, Na₂S, Na₂SO₄, Na₃PO₄, B₂O₃, P₂O₅, P₂O₃, Al₂O₃, SiO₂, V₂O₅, CaO, MgO, BaO, TiO₂, GeO₂, SiS₂, Sb₂O₃, SnS, TaS₂, P₂S₅, B₂S₃, and a combination of two or more thereof. More preferably, the solid electrolyte composite of the present invention includes wherein the glass material is Na₂O—B₂O₃.

In a preferred embodiment of the solid electrolyte of the present invention, as described herein, formula NaₓA_{y}B_{z}P_{3-z}O_{w} is provided wherein x is 3, A is Zr, y is 2, B is Si, z is 2 and w is 12 such that formula NaₓA_{y}B_{z}P_{3-z}O_{w} is Na₃Zr₂Si₂PO₁₂.

In a more preferred embodiment of the present invention, the solid electrolyte includes wherein the glass material is Na₂O—B₂O₃ and formula NaₓA_{y}B_{z}P_{3-z}O_{w} is Na₃Zr₂Si₂PO₁₂. Most preferably, the molar ratio of the Na₃Zr₂Si₂PO₁₂ to Na₂O—B₂O₃ is 12.2:1.

In another embodiment of this invention, the solid electrolyte composite of the present invention, as described herein, provides wherein the formula NaₓA_{y}B_{z}P_{3-z}O_{w} includes wherein x is 1, A is Zr, y is 2, z is 0 and w is 12 such that formula NaₓA_{y}B_{z}P_{3-z}O_{w} is NaZr₂(PO₄)₃.

The present invention provides the solid electrolyte composite, as described herein, preferably in the form of a powder, a film, a pellet, or a sheet.

The solid electrolyte composite of the present invention includes a glass material for reducing a grain boundary resistivity of the sodium-super-ionic-conductor framework.

In another embodiment of the present invention, a sodium-ion conducting solid electrolyte composite is provided comprising a sodium-ion conductive substance comprising a sodium-super-ionic-conductor framework of the formula NaₓA_{y}B_{z}P_{3-z}O_{w}E wherein A is one or more metal ions, B is one or more ions with a pentavalence, and x is a number ranging from 1 to 12, y is a number ranging from 1 to 2, z is a number ranging from 0 to 3, and w is a number ranging from 4 to 12 and wherein “E” is a glass material. Preferably, the sodium-ion conducting solid electrolyte composite, as described herein, has a molar ratio of the NaₓA_{y}B_{z}P_{3-z}O_{w} to the glass material ranging from about 100:1 to about 1:4. Preferably, “B” in the formula NaₓA_{y}B_{z}P_{3-z}O_{w} is one or more ions having a valence of 5+, such as for example, but not limited to Si5+, V5+ and Nb5+.

In a preferred embodiment of the sodium-ion conducting solid electrolyte composite of the present invention the glass material is one or more selected from the group consisting of Na₂O, Na₂S, Na₂SO₄, Na₃PO₄, B₂O₃, P₂O₅, P₂O₃, Al₂O₃, SiO₂, V₂O₅, CaO, MgO, BaO, TiO₂, GeO₂, SiS₂, Sb₂O₃, SnS, TaS₂, P₂S₅, B₂S₃, and a combination of two or more thereof. More preferably, the sodium-ion conducting solid electrolyte composite of the present invention includes wherein the glass material is Na₂O—B₂O₃. Preferably, the sodium-ion conducting solid electrolyte composite of the present invention includes wherein the formula NaₓA_{y}B_{z}P_{3-z}O_{w}E, x is 3, A is Zr, y is 2, B is Si, z is 2 and w is 12 such that said formula NaₓA_{y}B_{z}P_{3-z}O_{w} is Na₃Zr₂Si₂PO₁₂. In another preferred embodiment, the sodium-ion conducting solid electrolyte composite of the present invention includes wherein the glass material is Na₂O—B₂O₃ and the formula NaₓA_{y}B_{z}P_{3-z}O_{w} is Na₃Zr₂Si₂PO₁₂. Most preferably, the sodium-ion conducting solid electrolyte composite comprises wherein the molar ratio of the Na₃Zr₂Si₂PO₁₂ to the Na₂O—B₂O₃ glass material is 12.2:1.

Another embodiment of the present invention provides a sodium-ion conducting solid electrolyte composite, as described herein, wherein the formula NaₓA_{y}B_{z}P_{3-z}O_{w}E includes wherein x is 1, A is Zr, y is 2, z is 0, and w is 12 such that said formula NaₓA_{y}B_{z}P_{3-z}O_{w} is NaZr₂(PO₄)₃.

In yet another embodiment of this invention, a battery is provided comprising at least one cathode, at least one anode, and a solid electrolyte composite disposed on or between the cathode and the anode, the solid electrolyte composite comprising a substance having a sodium-super-ionic-conductor framework of the formula NaxAyBzP3-zOw E wherein A is one or more metal ions, B is one or more ions with a pentavalence, and x is a number ranging from 1 to 12, y is a number ranging from 1 to 2, z is a number ranging from 0 to 3, and w is a number ranging from 4 to 12, and E is a glass material, and optionally a polymer or copolymer protective layer disposed between the solid electrolyte composite and the anode. Preferably, “B” in the formula NaₓA_{y}B_{z}P_{3-z}O_{w} is one or more ions having a valence of 5+, such as for example, but not limited to Si5+, V5+ and Nb5+. Preferably, the battery includes wherein the solid electrolyte composite has a molar ratio of the NaxAyBzP3-zOw to the glass material ranging from about 100:1 to about 1:4. In a preferred embodiment, the battery includes wherein the glass material E of the solid electrolyte composite is one or more selected from the group consisting of Na₂O, Na₂S, Na₂SO₄, Na₃PO₄, B₂O₃, P₂O₅, P₂O₃, Al₂O₃, SiO₂, V₂O₅, CaO, MgO, BaO, TiO₂, GeO₂, SiS₂, Sb₂O₃, SnS, TaS₂, P₂S₅, B₂S₃, and a combination of two or more thereof. More preferably, the battery of the present invention, as described herein, includes wherein the glass material E is Na₂O—B₂O₃.

In a preferred embodiment, the battery of the present invention, as described herein, includes wherein the formula NaxAyBzP3-zOw is Na₃Zr₂Si₂PO₁₂. More preferably, the battery of the present invention, as described herein, includes wherein the glass material E is Na₂O—B₂O₃ and formula NaxAyBzP3-zOw is Na₃Zr₂Si₂PO₁₂. Most preferably, the battery of this invention includes wherein the molar ratio of the Na₃Zr₂Si₂PO₁₂ to Na₂O—B₂O₃ is 12.2:1.

Another embodiment provides for a battery of the present invention, as described herein, wherein the formula NaxAyBzP3-zOw is NaZr₂(PO₄)₃.

Yet other embodiments of this invention provide a method of producing a solid electrolyte composite comprising preparing a powder having a composition of NaxAyBzP3-zOw wherein A is one or more metal ions, B is one or more ions with a pentavalence, and x is a number ranging from 1 to 12, y is a number ranging from 1 to 2, z is a number ranging from 0 to 3, and w is a number ranging from 4 to 12, incorporating a glass material into the NaxAyBzP3-zOw powder resulting in a molar ratio of the NaxAyBzP3-zOw powder to the glass material in the range of from about 100:1 to about 1:4 for forming a NaxAyBzP3-zOw/glass material, and performing a powder compacting technique on the NaxAyBzP3-zOw/glass material to form a solid electrolyte composite. Preferably, “B” in the formula NaₓA_{y}B_{z}P_{3-z}O_{w} is one or more ions having a valence of 5+, such as for example, but not limited to Si5+, V5+ and Nb5+. This method includes, for example but not limited to, wherein the powder compacting technique comprises one or more of tape casting, pressing, pelletizing, sintering, and annealing, and combinations thereof. Preferably, this method of producing a solid electrolyte composite of the present invention, includes wherein the glass material is one or more selected from the group consisting of Na₂O, Na₂S, Na₂SO₄, Na₃PO₄, B₂O₃, P₂O₅, P₂O₃, Al₂O₃, SiO₂, V₂O₅, CaO, MgO, BaO, TiO₂, GeO₂, SiS₂, Sb₂O₃, SnS, TaS₂, P₂S₅, B₂S₃, and a combination of two or more thereof. The method of producing a solid electrolyte composite of the present invention, as described herein, includes a powder compacting technique that produces the solid electrolyte in a powder form, a film, a pellet, or a sheet.

### BRIEF DESCRIPTION OF THE FIGURES

FIG. 1 shows a schematic of the battery of the present invention having the NaSICON/glass electrolyte (i.e described herein as formula NaxAyBzP3-zOwE) between the cathode and the anode.

FIG. 2 shows the NaSICON structure wherein M1 sites and M2 sites correspond to Na₁ and Na₂ ions of the sodium-super-ionic-conductor framework of the formula NaxAyBzP3-zOw of the present invention.

FIG. 3 shows the solid electrolyte composite structure of the present invention wherein interstitial space is filled with Na-conducting glass (described herein as glass material “E”).

FIG. 4a shows that the barrier height changes proportionally to space-charge layer width. FIG. 4b shows redistribution of charge due to amorphous glass layer of the present invention encasing the grain reducing the space-charge layer width, lowering the barrier height.

FIG. 5 shows an EIS spectra of NaSICON (“NAS-25” and “NAS-100”, at 25 and 100 degrees Centigrade, respectively) and NaSICON/G-25 and NaSICON/G-100 (the sodium-super-ionic-conductor framework of the formula NaₓA_{y}B_{z}P_{3-z}O_{w}E, of the present invention) at 25 and 100 degrees Centigrade, respectively.

FIG. 6a (left side) shows the SEM image of Na₃Zr₂Si₂PO₁₂, and FIG. 6b (right side) shows the SEM image of Na₃Zr₂Si₂PO₁₂/Na₂O—B₂O₃ composite electrolyte of the present invention.

FIG. 7 shows an equation (eq. 4.1) describing typical grain transport.

### DETAILED DESCRIPTION OF THE INVENTION

The present invention provides a solid electrolyte composite comprising a sodium-super-ionic-conductor framework of the formula NaₓA_{y}B_{z}P_{3-z}O_{w} wherein A is one or more metal ions, B is one or more ions having a pentavalence, and x is a number ranging from 1 to 12, y is a number ranging from 1 to 2, z is a number ranging from 0 to 3, and w is a number ranging from 4 to 12, and a glass material. “B” in the formula NaₓA_{y}B_{z}P_{3-z}O_{w} may be present or absent. As used herein, the term “ion” refers to an element of the periodic table that has either lost or gained one or more electrons. An ion with a positive valence has lost one or more electrons. Preferably, “B” in the formula NaₓA_{y}B_{z}P_{3-z}O_{w} is one or more ions having a valence of 5+, such as for example, but not limited to Si5+, V5+ and Nb5+. The molar ratio of the NaₓA_{y}B_{z}P_{3-z}O_{w} to the glass material ranges from about 100:1 to about 1:4. Preferably, the solid electrolyte composite of the present invention, as described herein, includes a glass material that is one or more selected from the group consisting of Na₂O, Na₂S, Na₂SO₄, Na₃PO₄, B₂O₃, P₂O₅, P₂O₃, Al₂O₃, SiO₂, V₂O₅, CaO, MgO, BaO, TiO₂, GeO₂, SiS₂, Sb₂O₃, SnS, TaS₂, P₂S₅, B₂S₃, and a combination of two or more thereof. More preferably, the solid electrolyte composite of the present invention includes wherein the glass material is Na₂O—B₂O₃. In a preferred embodiment of the solid electrolyte of the present invention, as described herein, formula NaₓA_{y}B_{z}P_{3-z}O_{w} is provided wherein x is 3, A is Zr, y is 2, B is Si, z is 2 and w is 12 such that formula NaₓA_{y}B_{z}P_{3-z}O_{w} is Na₃Zr₂Si₂PO₁₂. In a more preferred embodiment of the present invention, the solid electrolyte includes wherein the glass material is Na₂O—B₂O₃ and formula NaₓA_{y}B_{z}P_{3-z}O_{w} is Na₃Zr₂Si₂PO₁₂. Most preferably, the molar ratio of the Na₃Zr₂Si₂PO₁₂ to Na₂O—B₂O₃ is 12.2:1.

In another embodiment of this invention, the solid electrolyte composite of the present invention, as described herein, provides wherein the formula NaₓA_{y}B_{z}P_{3-z}O_{w} includes wherein x is 1, A is Zr, y is 2, B is absent, z is 0 and w is 12 such that formula NaₓA_{y}B_{z}P_{3-z}O_{w} is NaZr₂(PO₄)₃.

The present invention provides the solid electrolyte composite, as described herein, preferably in the form of a powder, a film, a pellet, or a sheet.

The solid electrolyte composite of the present invention includes a glass material for reducing a grain boundary resistivity of the sodium-super-ionic-conductor framework.

In another embodiment of the present invention, a sodium-ion conducting solid electrolyte composite is provided comprising a sodium-ion conductive substance comprising a sodium-super-ionic-conductor framework of the formula NaₓA_{y}B_{z}P_{3-z}O_{w}E wherein A is one or more metal ions, B is one or more ions having a pentavalence, and x is a number ranging from 1 to 12, y is a number ranging from 1 to 2, z is a number ranging from 0 to 3, and w is a number ranging from 4 to 12, and wherein “E” is a glass material. “B” in the formula NaₓA_{y}B_{z}P_{3-z}O_{w} may be present or absent. Preferably, “B” in the formula NaₓA_{y}B_{z}P_{3-z}O_{w} is one or more ions having a valence of 5+, such as for example, but not limited to Si5+, V5+ and Nb5+. Preferably, the sodium-ion conducting solid electrolyte composite, as described herein, has a molar ratio of the NaₓA_{y}B_{z}P_{3-z}O_{w} to the glass material ranging from about 100:1 to about 1:4. In a preferred embodiment of the sodium-ion conducting solid electrolyte composite of the present invention the glass material is one or more selected from the group consisting of Na₂O, Na₂S, Na₂SO₄, Na₃PO₄, B₂O₃, P₂O₅, P₂O₃, Al₂O₃, SiO₂, V₂O₅, CaO, MgO, BaO, TiO₂, GeO₂, SiS₂, Sb₂O₃, SnS, TaS₂, P₂S₅, B₂S₃ and a combination of two or more thereof. More preferably, the sodium-ion conducting solid electrolyte composite of the present invention includes wherein the glass material is Na₂O—B₂O₃. Preferably, the sodium-ion conducting solid electrolyte composite of the present invention includes wherein the formula NaₓA_{y}B_{z}P_{3-z}O_{w}E, x is 3, A is Zr, y is 2, B is Si, z is 2 and w is 12 such that said formula NaₓA_{y}(PO_{z})_{w} is Na₃Zr₂Si₂PO₁₂.

In another preferred embodiment, the sodium-ion conducting solid electrolyte composite of the present invention includes wherein the glass material is Na₂O—B₂O₃ and the formula NaₓA_{y}B_{z}P_{3-z}O_{w} is Na₃Zr₂Si₂PO₁₂. Most preferably, the sodium-ion conducting solid electrolyte composite comprises wherein the molar ratio of the Na₃Zr₂Si₂PO₁₂ to the Na₂O—B₂O₃ glass material is 12.2:1.

Another embodiment of the present invention provides a sodium-ion conducting solid electrolyte composite, as described herein, wherein the formula NaₓA_{y}B_{z}P_{3-z}O_{w}E includes wherein x is 1, A is Zr, y is 2, B is absent, z is 0, and w is 12 such that said formula NaₓA_{y}B_{z}P_{3-z}O_{w} is NaZr₂(PO₄)₃.

In yet another embodiment of this invention, a battery is provided comprising at least one cathode, at least one anode, and a solid electrolyte composite disposed on or between the cathode and the anode, the solid electrolyte composite comprising a substance having a sodium-super-ionic-conductor framework of the formula NaₓA_{y}B_{z}P_{3-z}O_{w}E wherein A is one or more metal ions, B is one or more ions having a pentavalence, and x is a number ranging from 1 to 12, y is a number ranging from 1 to 2, z is a number ranging from 0 to 3, and w is a number ranging from 4 to 12, and E is a glass material, and optionally a polymer or copolymer protective layer disposed between the solid electrolyte composite and the anode. “B” in the formula NaₓA_{y}B_{z}P_{3×z}O, may be present or absent. Preferably, “B” in the formula NaₓA_{y}B_{z}P_{3-z}O_{w} is one or more ions having a valence of 5+, such as for example, but not limited to Si5+, V5+ and Nb5+. The polymer or copolymer protective layer, for example may be an elastomer. The elastomer may be a thermosetting or a thermoplastic polymer or copolymer. For example, the elastomer may be, but not limited to, a natural or a synthetic rubber, a polyisoprene, a copolymer of ethylene and propylene, a polyacrylic rubber, a silicone rubber, a polyether block amide, and an ethylene-vinyl acetate.

Preferably, the battery includes wherein the solid electrolyte composite has a molar ratio of the NaₓA_{y}B_{z}P_{3-z}O_{w} to the glass material ranging from about 100:1 to about 1:4. In a preferred embodiment, the battery includes wherein the glass material E of the solid electrolyte composite is one or more selected from the group consisting of Na₂O, Na₂S, Na₂SO₄, Na₃PO₄, B₂O₃, P₂O₅, P₂O₃, Al₂O₃, SiO₂, V₂O₅, CaO, MgO, BaO, TiO₂, GeO₂, SiS₂, Sb₂O₃, SnS, TaS₂, P₂S₅, B₂S₃, and a combination of two or more thereof. More preferably, the battery of the present invention, as described herein, includes wherein the glass material E is Na₂O—B₂O₃. In a preferred embodiment, the battery of the present invention, as described herein, includes wherein the formula NaₓA_{y}B_{z}P_{3-z}O_{w} is Na₃Zr₂Si₂PO₁₂. More preferably, the battery of the present invention, as described herein, includes wherein the glass material E is Na₂O—B₂O₃ and formula NaₓA_{y}B_{z}P_{3-z}O_{w} is Na₃Zr₂Si₂PO₁₂. Most preferably, the battery of this invention includes wherein the molar ratio of the Na₃Zr₂Si₂PO₁₂ to Na₂O—B₂O₃ is 12.2:1.

Another embodiment provides for a battery of the present invention, as described herein, wherein the formula NaₓA_{y}B_{z}P_{3-z}O_{w} is NaZr₂(PO₄)₃.

Yet other embodiments of this invention provide a method of producing a solid electrolyte composite comprising preparing a powder having a composition of NaₓA_{y}B_{z}P_{3-z}O_{w}, wherein A is one or more metal ions, B is one or more ions having a pentavalence, and x is a number ranging from 1 to 12, y is a number ranging from 1 to 2, z is a number ranging from 0 to 3, and w is a number ranging from 4 to 12, incorporating a glass material into the NaₓA_{y}B_{z}P_{3-z}O_{w} powder resulting in a molar ratio of the NaₓA_{y}B_{z}P_{3-z}O_{w} powder to the glass material in the range of from about 100:1 to about 1:4 for forming a NaₓA_{y}B_{z}P_{3-z}O_{w}/glass material, and performing a powder compacting technique on the NaₓA_{y}B_{z}P_{3-z}O_{w}/glass material to form a solid electrolyte composite. This method includes, for example but not limited to, wherein the powder compacting technique comprises one or more of tape casting, pressing, pelletizing, sintering, and annealing, and combinations thereof. Preferably, this method of producing a solid electrolyte composite of the present invention, includes wherein the glass material is one or more selected from the group consisting of Na₂O, Na₂S, Na₂SO₄, Na₃PO₄, B₂O₃, P₂O₅, P₂O₃, Al₂O₃, SiO₂, V₂O₅, CaO, MgO, BaO, TiO₂, GeO₂, SiS₂, Sb₂O₃, SnS, TaS₂, P₂S₅, B₂S₃, and a combination of two or more thereof. The method of producing a solid electrolyte composite of the present invention, as described herein, includes a powder compacting technique that produces the solid electrolyte in a powder form, a film, a pellet, or a sheet.

It will be understood by those persons skilled in the art that the present invention provides an advanced sodium super ionic conductor-composite electrolyte material for a low-cost, utility-scale battery that will operate at 120° C. to 250° C. The electrolyte is based on a NaSICON/glass electrolyte composite technology as described herein. An optimal sodium-conducting glass which, when used to encase single grains of NaSICON, will minimize NaSICON's grain boundary resistivity, protect the material from the detrimental effects of the sodium anode, and maintain compatibility with a sulfur-carbon composite cathode which itself has a 3-D NaSICON structure. The sodium conducting glass (referred to as “E” in the formula NaₓA_{y}B_{z}P_{3-z}O_{w}E, is described herein).

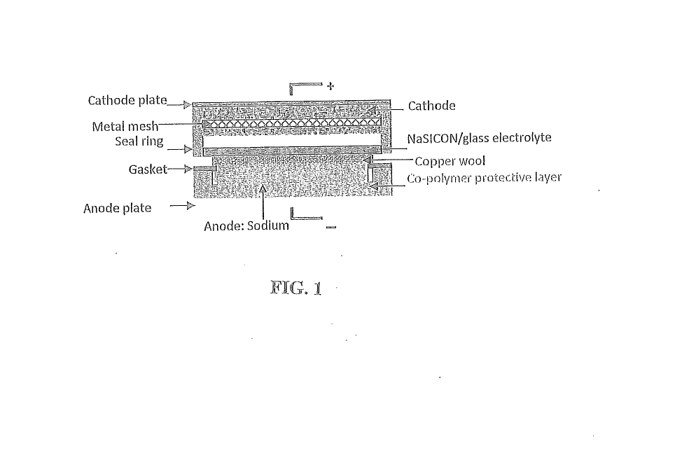

The NaSICON/glass-composite electrolyte of the present invention is targeted to operate at temperatures from 120° C. to 250° C. with performance comparable to polycrystalline β″-Al₂O₃ at 300° C. The battery of the present invention is fashioned in a planar configuration, but other configurations known by those skilled in the art are suitable. In an optional embodiment of this invention, the battery, at the anode side, includes an embedded elastic, polymer protective layer (for example a copolymer protective layer as shown in FIG. 1) with the ability to expand and contract as the volume of sodium changes during charge/discharge cycle to ensure good contact between the anode and the electrolyte, such as elastomer polymers.

FIG. 1 shows the planar configuration of the battery of the present invention. Other configuration shapes may be used in the embodiments of this invention as will be understood by those persons skilled in the art. The schematic shown in FIG. 1 depicts an example of the battery of the present invention which incorporates an optional co-polymer protective layer to enhance contact between the sodium anode and glassy NaSICON electrolyte.

### Electrolyte Material Development and Characterization

Although NaSICON has been identified as an excellent candidate for low-temperature Na-battery electrolyte applications, the material suffers three serious flaws: low grain boundary ionic conductivity, high porosity, and potential long-term instability when in contact with molten sodium. The present invention provides a NaSICON/glass electrolyte composite that is both highly conductive and stable, and whose lower temperature offers operating cost savings.

J. B. Goodenough, H. Y. P. Hong and J. A. Kafalas (1976), Mater. Res. Bull., 11, 203, realization of a three-dimensional (3-D) framework for cation transport and the ensuing development of the Na-Super-Ionic-Conductor (NaSICON) family of materials caused a tremendous wave of electrolyte investigations. The NaSICON group with general formula of NaA₂(PO₄)₃ consists of an interconnected group of [AO₆] octahedra and [PO₄] tetrahedra (where A=Ge, Ti, Zr, et al.) that share common corners creating 3-D channels for Na-ion transport.

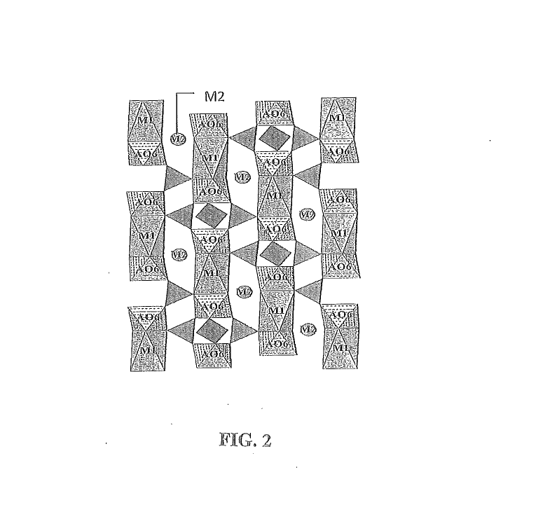

Two types of interstitial spaces (M1 and M2, see FIG. 2, as set forth in Rachid Essehli, Brahim El Bali, Said Benmokhtar, Khalid Bouziane, Bouchaib Manoun, Mouner Ahmed Abdalslam, Helmut Ehrenberg, Journal of Alloys and Compounds 509 (2011) 1163) can be occupied by Na ions, depending on the nature of substitution cations (Al, Cr, Fe, Y, Yb, et al.) for A sites. For example, partial substitution of PO₄ with SiO₄ in NaZr₂(PO₄)₃ results in the partial filling of the M2 sites thereby increasing the number of Na interstitial sites and allowing for better conduction through vacancy transport. Since this is a hopping style of transport, increased conductivity has been found with higher Na content. See, for example, W. Bogusz, F. Krok and W. Jakubowski (1983), Solid State Ion, 9 & 10, 803, and W. Wang, D. Li and J. Zhao (1992), Solid State Ion 51, 97. The substitution of Zr⁴+ in the octahedral sites can cause further charge compensation resulting in greater Na-ion content. Also bottlenecks change size through which Na ions may move from M1 to M2 sites.

The 3-D conduction pathway of NaSICON structure is volumetrically greater than, and not subject to, the grain orientation limitations (see, X. Lu, G. Xia, J. P. Lemmon and Z. Yang (2009), J. Power Sour., 195, 2431-2442) (aspect ratio) in the β″-Al₂O₃ structure. Earlier researchers found that replacing NaSICON's A-site cations led to conductivity rivaling that of liquid electrolytes at lower excitation temperatures than required in the application of β″-Al₂O₃ (see, for example, K. Ivanov-Schitz and A. B. Bykov (1997), Solid State Ion, 100, 153; D. Kreuer, H. Kohler, U. Warhus and H. Schulz (1986), Mater Res Bull, 21, 149; and J. D. Canaday, A. K. Kuriakose, T. A Wheat, A. Ahmad, J. Gulens and B. W. Hildebrandt (1989), Solid State Ion, 35, 165). What was likewise discovered was that NaSICON was subject to mechanical failure after only a short period of contact with molten sodium (see, for example, H. Schmid, L. C. De Jonghe and C. Cameron (1982) Solid State Ion, 6, 57). The NaSICON/glass composite of the present invention overcomes these issues.

Fundamental crystal chemistry dictates the following requirements for fast ionic transport:
1. Similar lattice position potentials to prevent activation bottlenecks
2. Sub-lattice disorder allowing for a larger number of possible positions for mobile ions thus lowering the required activation energy.
3. Intra-lattice pathways with dimensions approximately twice the radius of the mobile ions.
4. Covalent lattice bonds with ionic interstitial bonding.
   In the NaSICON material NaZr₂(PO₄)₃, Na ions in M₁ sites must cross empty M₂ sites, violating the first two requirements above, resulting in a low conductivity. The introduction of SiO₄ addresses requirements 1 and 2 by partial filling of the M2 sites thereby increasing the number of Na interstitial sites. Because requirements 3 and 4 are inherent in the NaSICON structure to varying degrees, based on dopants and fabrication methods, NaSICON presents itself as an intriguing basis for study.

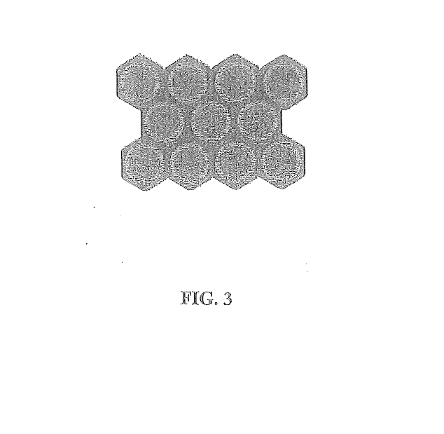

Glassy Na conductors lack the 3-D pathway found in NaSICON and consequently offer lesser conductivity, while crystal NaSICON suffers from high grain boundary losses. While, W. Bogusz, F. Krok and W. Piszczatowski (1999), Solid State Ion, 119, 165, sets forth that during the fabrication of NaSICON a glass phase between 10% to 30% is invariably formed, this phase is neither as conductive as other glass mixtures nor does it cover all grain boundaries to prevent inter-grain potentials. To address these issues, we created single grain particles and amalgamate these with an optimized Na conducting glass. This lowers the barrier of conductivity at the interface of the amorphous solid/grain boundary as opposed to the energetically demanding grain/grain interface (see S. Jiang and J. B. Wagner (1995), J. Phys. Chem. Solids, 56, 1101). The result is a composite of the present invention with the higher bulk conductivity of NaSICON without its grain barrier losses. FIG. 3 shows the solid electrolyte composite structure of the present invention wherein interstitial space is filled with Na-conducting glass (described herein as glass material “E”).

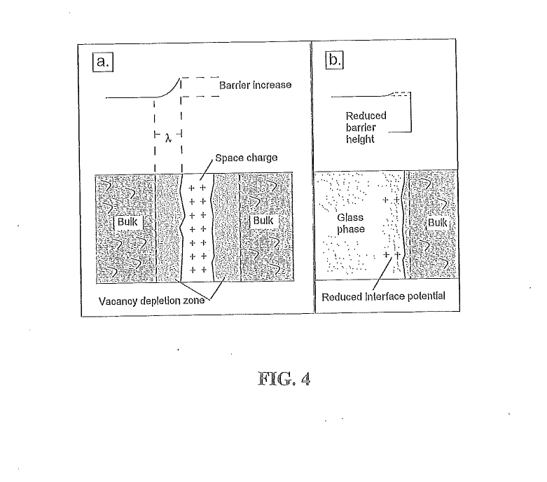

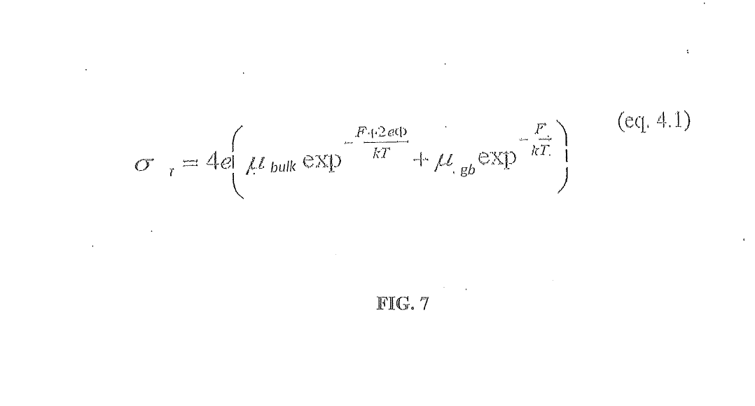

The presence of a space charge layer at the grain boundary of polycrystalline materials also has generated a great deal of research in the past few decades. The ultimate reasons for, and effects of, this grain boundary potential vary with the material. Yet all invariably are linked to defect chemistry and the degradation of bulk concentrations at the surface to accommodate surface/bulk/ambient energy interactions. Typical grain transport can be described by the equation 4.1 set forth in FIG. 7. In the equation of FIG. 7, k is the Boltzmann constant, T refers to absolute temperature, μ is the vacancy mobility, Φ is the potential between bulk and grain boundary, and F is a function of defect concentrations and the space charged layer width, λ (shown for reference in FIG. 4).

FIG. 4(a) shows how the barrier height changes proportionally to space-charge layer width, λ, at the grain exterior region (light gray area) where an increase of defects results in a blocking potential between like-charged grain exteriors. The transport vacancy concentrations decrease in a gradient from bulk values due to a defect concentration increase in the grain boundary region. The interface between a grain and an amorphous layer must experience charge redistribution, but will be absent of a typical grain boundary blocking barrier since the glass phase is formed too fast to allow defect movement. The result will be a lowering of Φ, increasing the first term (bulk conductivity) of the above equation, while also increasing the second term (grain boundary conductivity) by drastically shortened λ (FIG. 4b), resulting in a greatly enhanced total conductivity.

The utilization of the long-term stability of glass with molten Na will provide great benefit. That is, the presence of an inert glassy phase at the anode interface will effectively annul previously observed Na poisoning effects on NaSICON's structure. Na-conducting glass possesses no grain boundary, thereby disallowing Na conglomeration, thus eliminating the grain boundary barrier. As such, this composite mixture provides a solid foundation for a prospective low-temperature, high-conducting, stable Na ion conduction electrolyte.

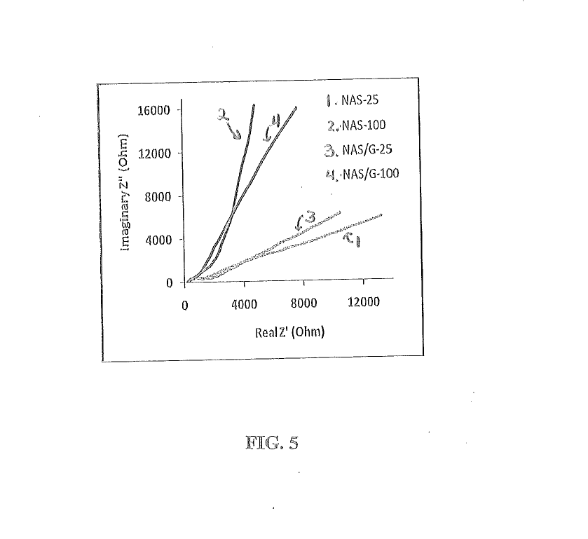

We have tested a mixed-phase, mixed-composition compound of the present invention, namely, Na₃Zr₂Si₂PO₁₂/Na₂O—B₂O₃, compared to as-prepared NaSICON. Conductivity measurements showed an impressive 300% overall conductivity improvement for the composite electrolyte of the present invention, see FIG. 5.

In this invention, we disclose a novel NaSICON/glass composite electrolyte, which makes Na-type battery be able to operate at 120-250° C. Glass phase in the composite electrolyte is used to fill NaSICON grain boundaries with the elimination of NaSICON grain boundary effect and the stability improvement in contact with Na anode. The advantages of this invention lie mainly in the enhancement of Na-ion conductivity in the new electrolytes and long-term compatibility with Na at the temperature range of 120-250° C. for Na-type battery systems.

The solid state reaction method will be used to obtain the NaSICON phase. Na-ion conducting glass will be prepared by melt-quenching method. Also, the fabrication procedures of NaSICON and glass composites involve the ball milling, heat treatments, and grinding to form the NaSICON/glass composite powder.

Low-cost ceramic processing techniques including tape casting, pressing and sintering can be used to prepare the NaSICON/glass electrolyte in the form of thin film, pellets, or sheet. The sodium-ion (Na-ion) conducting glass consist of at least one of, and preferably two or more, selected from the group consisting of Na₂O, Na₂S, Na₂SO₄, Na₃PO₄, B₂O₃, P₂O₅, P₂O₃, Al₂O₃, SiO₂, V₂O₅, CaO, MgO, BaO, TiO₂, GeO₂, SiS₂, Sb₂O₃, SnS, TaS₂, P₂S₅, B₂S₃, and combinations thereof. Preferably, the molar ratio of the NaSICON to the glass material ranges from about 100:1 to about 1:4.

The composite electrolyte materials of this invention will be produced in the form of powder, pellet, thin film or sheet. The thin films and sheets preferably have a thickness, for example but not limited to, ranging from about 10 microns to about 1 mm.

The conventional Na-type battery, for example Na-S and ZEBRA (Na—NiC12), see Broadhead, John, Sodium-sulfur batteries, U.S. Pat. No. 4,054,728; Cord-H. Dustmann, Journal of Power Sources 127 (2004) 85; and X. Lu, G. Xia, J. Lemmon, Z. Yang, Journal of Power Sources 195 (2009) 2431, is composed of sodium anode, beta-alumina electrolyte and sulphur/metal chloride in the tubular form. Of the most significant problem of the Na-type battery is its high operating temperature above 250° C., which could induce serious practical difficulties associated with explosions, corrosion and power consumption. Reducing the operating temperatures of Na-type batteries allows for improvement in material durability, use of more cost effective materials, and easier thermal management. This requires the optimization of current electrolyte that can demonstrate facile Na-ion transport at the reduced temperatures.

NaSICON-type materials, see Enrique R. Losilla, Miguel A. G. Aranda, and Sebastian Bruque, Chem. Mater. 12 (2000) 2134; Ignaszak, P. Pasierb, R. Gajerski, S. Komornicki, Thermochimica Acta 426 (2005) 7; and N. Anantharamulu, K. Koteswara Rao, G. Rambabu, B. Vijaya Kumar, Velchuri Radha, M. Vithal, J Mater Sci 46 (2011) 2821, with the general formula Nal+xZr2SixP3−xO12 (0≦x≦3) have been widely studied for replacing beta-alumina electrolyte during last few years. A large number of related materials have been synthesized based on partial metal substitution at the octahedral metal site to give Nal+xM2−xNxP3O12 (M=Ti, Ge Yb, or Hf, N═Al, In, Y or Cr), see Frank J. Berry, Nicola Costantini, Lesley E. Smart, Synthesis and characterisation of Cr3+− containing NaSICON-related phases, Solid State Ionics 177 (2006) 2889, or Na3+xZr2−xMxSi2PO12 (M=Mg, Yb and Nb), see Zu-Xiang Lin, Hui-Jun Yu, Shun-Bal Tian, Shi-Chun Li, Solid State Ionics 40/41 (1990) 59, with crystalline phase structure. The main impediments to the practical use of NaSICON ceramic as a solid electrolyte, however, are low grain boundary conductivity, high porosity effects and instability in contact with metal Na. Vitrification of the crystal compounds have been attempted in order to solve these problems. For example, L. Moreno-Real, P. Maldonado-Manso, et al., Journal of Materials Chemistry 12 (2002) 3681, reported a sodium ionic conductivity of the order of 10⁻⁶ S/cm at 150° C. in the NaSICON amorphous compound. Q. Zhang, Z Wen, Y. Liu, S. Song, X. Wu, Journal of Alloys and Compounds 479 (2009) 494, fabricated the Na₁₊ₓAlₓGe₂-xP₃O₁₂ electrolyte in the form of glass—ceramics. Nevertheless, the NaSICON glass phase is neither as conductive as other glass mixtures nor does it cover all grain boundaries to prevent inter-grain potentials.

To avoid these problems encountered by others, the NaSICON/glass composite electrolyte of the present invention has improved Na-ion conductivity, reduced porosity and increased compatibility with metal Na for low-temperature Na-type batteries. An optimized Na-conducting glass is employed in the present invention to fill and cover all NaSICON grain boundaries with the increased viscous flow and the non-bridging oxygen under reduced temperature operation of Na-ion batteries. This lowers the conduction barrier among NaSICON grains and avoids the direct contact of NaSICON with metal Na. As such, this invention provides an improved battery, namely a low temperature Na-type battery, using the novel NaSICON/glass based composite electrolytes of this invention.

### Preparation of Na₃Zr₂Si₂PO₁₂ (Powder)

3.975 g (gram) Na₂CO₃, 6.15 g ZrO2, 3.3 g (NH4)HPO4, and 3 g SiO₂ (molar ratio is 3:4:2:4, respectively) were initially mixed with 50 ml (milliliter) ethanol by ball milling for 24 h (hour) to obtain a mixture slurry. After drying the slurry, the mixture was heated in air at 300° C. (Centigrade) for 2 h, 600° C. for 4 h, and 1000° C. for 12 h to obtain a Na₃Zr₂Si₂PO₁₂ powder.

### Fabrication of Na₃Zr₂Si₂PO₁₂/Na₂O—B₂O₃ Composite Electrolyte

5.3 g Na₂CO₃ and 6.2 g H3BO3 (molar ratio is 1:2, respectively) were mixed in 30 ml ethanol through ball milling for 24 h and then sintered at 650° C. for 12 h to obtain Na₂O—B₂O₃ powder. 0.98 g of the as-prepared Na₃Zr₂Si₂PO₁₂ powder was mixed with 0.02 g Na₂O—B₂O₃ powder in 30 ml ethanol through ball milling for 24 h to obtain the Na₃Zr₂Si₂PO₁₂/Na₂O—B₂O₃ composite slurry. The Na₃Zr₂Si₂PO₁₂/Na₂O—B₂O₃ slurry was dried to form a powder, and then the obtained Na₃Zr₂Si₂PO₁₂/Na₂O—B₂O₃ composite powder was ground in a mortar. Afterwards, the Na₃Zr₂Si₂PO₁₂/Na₂O—B₂O₃ composite powder and polyvinyldene difluoride (PVDF) were mixed using a mass ratio of 300:1 and then pressed into pellets under 18,000 lb. of pressure. The pellets were sintered at 1200° C. for 2 h and then rapidly cooled in air. Finally, the pellets were annealed in a furnace at 400° C. for 2 h to obtain Na₃Zr₂Si₂PO₁₂/Na₂O—B₂O₃ composite electrolyte. The molar ratio of Na₃Zr₂Si₂PO₁₂ to Na₂O—B₂O₃ was 12.2:1.

### Surface Characterization & Conductivity Measurements

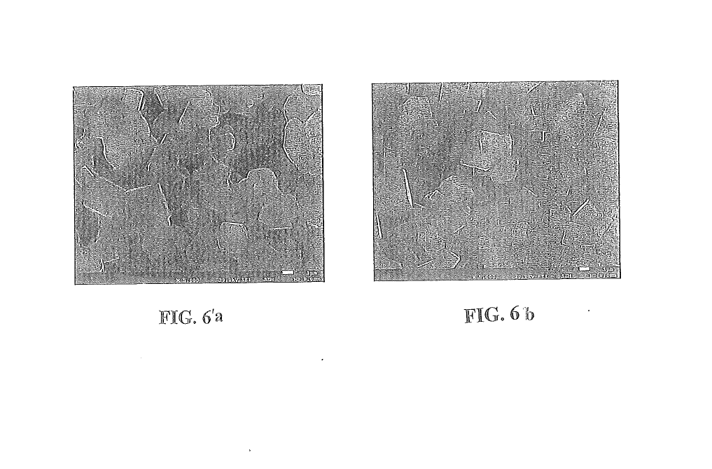

FIG. 6 shows SEM (scanning electron microscope) images of a typical Na₃Zr₂Si₂PO₁₂ electrolyte (FIG. 6a), and Na₃Zr₂Si₂PO₁₂/Na₂O—B₂O₃ composite electrolyte of the present invention (FIG. 6b). FIG. 6(a) shows that as-prepared Na₃Zr₂Si₂PO₁₂ electrolyte consists of heterogeneous grains with good crystallization and high porosity. The high porosity blocks the conduction path for Na ions. In the composite electrolyte of the present invention (FIG. 6b), an amorphous phase can clearly be identified between NaSICON grains. The SEM image of the composite sample also shows very dense and well-packed structure without any pores and cracks. The closer contact and high concentration of Na ions would favor the migration of Na ions at grain boundaries.

FIG. 5 shows representative impedance plots for typical Na₃Zr₂Si₂PO₁₂ electrolyte (FIG. 5 “NAS”), and Na₃Zr₂Si₂PO₁₂/Na₂O—B₂O₃ composite electrolyte of the present invention (FIG. 5 “NAS/G”) that were measured at 25 and 100° C. by impedance technique in the frequency range of 1.0 Hz-10 MHz, using silver paste as ion blocking electrode. The bulk and total conductivities of conventional Na₃Zr₂Si₂PO₁₂ electrolyte at 25° C. are σ_{b}=8.9×10⁴ S/cm and σₜ=3.5×10⁻⁵ S/cm, and the values at 100° C. are increased to σ_{b}=1.2×10⁻³ S/cm and σₜ=1.1×10⁴ S/cm. By contrast, the total conductivity of the NaSICON/Na₂O—B₂O₃ composite electrolyte of the present invention at 25° C. is almost one order of magnitude higher than that of the Na₃Zr₂Si₂PO₁₂. The total conductivity of the composite electrolyte of the present invention is 3 times higher than that of NaSICON at 100° C. It is noteworthy that the enhancement of the total conductivity can completely be attributed to the modification of NaSICON grain boundary of the present invention, since the bulk resistance remains nearly constant between the two electrolytes. Obviously, the employment of glass in the present invention has a major beneficial impact on Na-ion conduction in NaSICON crystals.

The various embodiments described herein are merely descriptive of the present invention and are in no way intended to limit the scope of the invention. Modifications of the present invention will become obvious to those having skill in the art in light of the detailed description herein, and such modifications are intended to fall within the scope of the appended claims.

1. A solid electrolyte composite comprising:
a sodium-super-ionic-conductor framework of the formula NaₓA_{y}B_{z}P_{3-z}O_{w} wherein A is one or more metal ions, B is one or more ions having a pentavalence, and x is a number ranging from 1 to 12, y is a number ranging from 1 to 2, z is a number ranging from 0 to 3, and w is a number ranging from 4 to 12, wherein B is present or absent; and
a glass material.

2. The solid electrolyte composite of claim 1 wherein the molar ratio of said NaₓA_{y}B_{z}P_{3-z}O_{w} to said glass material ranges from about 100:1 to about 1:4.

3. The solid electrolyte composite of claim 1 wherein said glass material is one or more selected from the group consisting of Na₂O, Na₂S, Na₂SO₄, Na₃PO₄, B₂O₃, P₂O₅, P₂O₃, Al₂O₃, SiO₂, V₂O₅, CaO, MgO, BaO, TiO₂, GeO₂, SiS₂, Sb₂O₃, SnS, TaS₂, P₂S₅, B₂S₃, and a combination of two or more thereof.

4. The inorganic solid electrolyte composite of claim 1 wherein said glass material is Na₂O—B₂O₃.

5. The solid electrolyte composite of claim 1 wherein x is 3, A is Zr, y is 2, B is Si, z is 2 and w is 12 resulting in the formula Na₃Zr₂Si₂PO₁₂.

6. The solid electrolyte composite of claim 1 wherein said glass material is Na₂O—B₂O₃ and said formula NaₓA_{y}B_{z}P_{3-z}O_{w} is Na₃Zr₂Si₂PO₁₂.

7. The solid electrolyte composite of claim 6 wherein the molar ratio of said Na₃Zr₂Si₂PO₁₂ to Na₂O—B₂O₃ is 12.2:1.

8. The solid electrolyte composite of claim 1 that is in a powder form, a film, a pellet, or a sheet.

9. The solid electrolyte composite of claim 1 wherein said x is 1, A is Zr, y is 2, B is absent, z is 0 and w is 12 resulting in the formula NaZr₂(PO₄)₃.

10. The solid electrolyte composite of claim 1 wherein said glass material reduces a grain boundary resistivity of said sodium-super-ionic-conductor framework.

11. A sodium-ion conducting solid electrolyte composite comprising:
a sodium-ion conductive substance comprising a sodium-super-ionic-conductor framework of the formula NaₓA_{y}B_{z}P_{3-z}O_{w}E wherein A is one or more metal ions, B is one or more ions having a pentavalence, and x is a number ranging from 1 to 12, y is a number ranging from 1 to 2, z is a number ranging from 0 to 3, and w is a number ranging from 4 to 12, wherein B is present or absent, and wherein “E” is a glass material.

12. The sodium-ion conducting solid electrolyte composite of claim 11 wherein the molar ratio of said NaₓA_{y}B_{z}P_{3-z}O_{w} to said glass material ranges from about 100:1 to about 1:4.

13. The sodium-ion conducting solid electrolyte composite of claim 11 wherein said glass material is one or more selected from the group consisting of Na₂O, Na₂S, Na₂SO₄, Na₃PO₄, B₂O₃, P₂O₅, P₂O₃, Al₂O₃, SiO₂, V₂O₅, CaO, MgO, BaO, TiO₂, GeO₂, SiS₂, Sb₂O₃, SnS, TaS₂, P₂S₅, B₂S₃, and a combination of two or more thereof.

14. The sodium-ion conducting solid electrolyte composite of claim 11 wherein said glass material is Na₂O—B₂O₃.

15. The sodium-ion conducting solid electrolyte composite of claim 11 wherein x is 3, A is Zr, y is 2, B is Si, z is 2 and w is 12 such that said formula NaₓA_{y}B_{z}P_{3-z}O_{w} is Na₃Zr₂Si₂PO₁₂.

16. The sodium-ion conducting solid electrolyte composite of claim 11 wherein said glass material is Na₂O—B₂O₃ and said formula NaₓA_{y}B_{z}P_{3-z}O_{w} is Na₃Zr₂Si₂PO₁₂.

17. The sodium-ion conducting solid electrolyte composite of claim 16 wherein the molar ratio of said Na₃Zr₂Si₂PO₁₂ to Na₂O—B₂O₃ is 12.2:1.

18. The sodium-ion conducting solid electrolyte composite of claim 11 wherein said x is 1, A is Zr, y is 2, B is absent, z is 0, and w is 12 such that said formula NaₓA_{y}B_{z}P_{3-z}O_{w} is NaZr₂(PO₄)₃.

19. A battery comprising:
at least one cathode;
at least one anode; and
a solid electrolyte composite disposed on or between the cathode and the anode, the solid electrolyte composite comprising a substance having a sodium-super-ionic-conductor framework of the formula NaxAyBzP3-zOwE wherein A is one or more metal ions, B is one or more ions having a pentavalence, and x is a number ranging from 1 to 12, y is a number ranging from 1 to 2, z is a number ranging from 0 to 3, and w is a number ranging from 4 to 12, wherein B is present or absent, and E is a glass material, and optionally a polymer or copolymer protective layer disposed between said solid electrolyte composite and said anode.

20. The battery of claim 19 wherein said solid electrolyte composite has a molar ratio of said NaₓA_{y}B_{z}P_{3-z}O_{w} to said glass material ranging from about 100:1 to about 1:4.

21. The battery of claim 19 wherein said glass material E of said solid electrolyte composite is one or more selected from the group consisting of Na₂O, Na₂S, Na₂SO₄, Na₃PO₄, B₂O₃, P₂O₅, P₂O₃, Al₂O₃, SiO₂, V₂O₅, CaO, MgO, BaO, TiO₂, GeO₂, SiS₂, Sb₂O₃, SnS, TaS₂, P₂S₅, B₂S₃, and a combination of two or more thereof.

22. The battery of claim 21 wherein said glass material E is Na₂O—B₂O₃.

23. The battery of claim 19 wherein said formula NaₓA_{y}B_{z}P_{3-z}O_{w} is Na₃Zr₂Si₂PO₁₂.

24. The battery of claim 19 wherein said glass material E is Na₂O—B₂O₃ and said formula NaₓA_{y}B_{z}P_{3-z}O_{w} is Na₃Zr₂Si₂PO₁₂.

25. The battery of claim 24 wherein the molar ratio of said Na₃Zr₂Si₂PO₁₂ to Na₂O—B₂O₃ is 12.2:1.

26. The battery of claim 19 wherein said formula NaₓA_{y}B_{z}P_{3-z}O_{w} is NaZr₂(PO₄)₃.

27. A method of producing a solid electrolyte composite comprising:
preparing a powder having a composition of NaₓA_{y}B_{z}P_{3-z}O_{w} wherein A is one or more metal ions, B is one or more ions having a pentavalence, and x is a number ranging from 1 to 12, y is a number ranging from 1 to 2, z is a number ranging from 0 to 3, and w is a number ranging from 4 to 12, wherein B is present or absent;
incorporating a glass material into said NaₓA_{y}B_{z}P_{3-z}O_{w} powder resulting in a molar ratio of said NaₓA_{y}B_{z}P_{3-z}O_{w} powder to said glass material in the range of from about 100:1 to about 1:4, and forming a NaₓA_{y}B_{z}P_{3-z}O_{w}/glass material; and
performing a powder compacting technique on the NaₓA_{y}B_{z}P_{3-z}O_{w}/glass material to form a solid electrolyte composite.

28. The method of producing a solid electrolyte composite of claim 27 wherein the powder compacting technique comprises one or more of tape casting, pressing, pelletizing, sintering, and annealing, and combinations thereof.

29. The method of producing a solid electrolyte composite of claim 27 wherein said glass material is one or more selected from the group consisting of Na₂O, Na₂S, Na₂SO₄, Na₃PO₄, B₂O₃, P₂O₅, P₂O₃, Al₂O₃, SiO₂, V₂O₅, CaO, MgO, BaO, TiO₂, GeO₂, SiS₂, Sb₂O₃, SnS, TaS₂, P₂S₅, B₂S₃, and a combination of two or more thereof.

30. The method of producing a solid electrolyte composite of claim 28 wherein the powder compacting technique produces said solid electrolyte in a powder form, a film, a pellet, or a sheet.
